(19) United States
(12) Patent Application Publication
(10) Pub. No.: US 2008/0061532 A1
(43) Pub. Date: Mar. 13, 2008

(54) Foldable vehicle

(76) Inventor: Chin-Chiao Chen, Taichung Hsien (TW)

Correspondence Address: SCHWEGMAN, LUNDBERG & WOESSNER, P.A., P.O. BOX 2938, MINNEAPOLIS, MN, 55402, US

(21) Appl. No.: 11/519,416

(22) Filed: Sep. 12, 2006

(51) Int. Cl. B62B 7/00

(52) U.S. Cl. 280/642

(57) ABSTRACT

A foldable vehicle includes a skeleton, a coupling member and a latch unit. The skeleton includes a base frame, front and rear supporting frames pivoted to the base frame, a pivoting member pivoted to the front and the rear supporting frames and having a first crossbar, and a second crossbar provided on one of the front and rear supporting frames. The coupling member is fixed to one of the first and second crossbars and is releasably coupled to the other of the first and second crossbars. The latch unit is mounted on the coupling member for preventing uncoupling between the coupling member and the other of the first and second crossbars.

### BACKGROUND OF THE INVENTION

1. Field of the Invention

The invention relates to a vehicle, more particularly to a foldable vehicle.

2. Description of the Related Art

Conventional carts for connecting with a bicycle or an electromotive vehicle normally require disassembly of parts therefrom for folding purpose, which is relatively inconvenient and laborious.

### SUMMARY OF THE INVENTION

Therefore, the object of the present invention is to provide a foldable vehicle that can overcome the aforesaid drawback associated with the prior art.

Accordingly, a foldable vehicle of the present invention includes a skeleton, a coupling member, and a latch unit. The skeleton is foldable between folded and extended positions and includes: a wheeled base frame having front and rear frame parts; a front supporting frame having a lower frame part pivoted to the front frame part of the wheeled base frame so as to be pivotable relative to the wheeled base frame about a first axis, and an upper frame part disposed opposite to the lower frame part; a rear supporting frame having a lower frame part pivoted to the rear frame part of the wheeled base frame so as to be pivotable relative to the wheeled base frame about a second axis that is parallel to the first axis, and an upper frame part disposed opposite to the lower frame part of the rear supporting frame; a pivoting member having a front part pivoted to the upper frame part of the front supporting frame so as to be pivotable relative to the front supporting frame about a third axis that is parallel to the first and second axes, a rear part pivoted to the upper frame part of the rear supporting frame so as to be pivotable relative to the rear supporting frame about a fourth axis that is parallel to the first, second and third axes, and a first crossbar parallel to the first, second, third, and fourth axes; and a second crossbar provided on one of the front and rear supporting frames and parallel to the first crossbar. The coupling member is fixed to one of the first and second crossbars, is coupled releasably to the other of the first and second crossbars when the skeleton is disposed at the extended position, and is uncoupled from the other of the first and second crossbars when the skeleton is disposed at the folded position. The latch unit is mounted on the coupling member for preventing uncoupling between the coupling member and the other of the first and second crossbars.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of the preferred embodiment of a foldable vehicle according to the present invention;

FIG. 2 is a fragmentary exploded perspective view of the preferred embodiment;

FIG. 3 is a fragmentary, partly sectional view to illustrate a state where a skeleton of the foldable vehicle of the preferred embodiment is disposed at an extended position, and a spring-biased latch is disposed at a locking position;

FIG. 4 is a fragmentary schematic view to illustrate how the skeleton of the foldable vehicle of the preferred embodiment is folded;

FIG. 5 is fragmentary, partly sectional view to illustrate a state where the spring-biased latch is disposed at an unlocking position so as to permit folding of the skeleton; and

FIG. 6 is an assembled perspective view to illustrate a state where the skeleton of the foldable vehicle of the preferred embodiment is fully folded.

### DETAILED DESCRIPTION OF THE PREFERRED EMBODIMENT

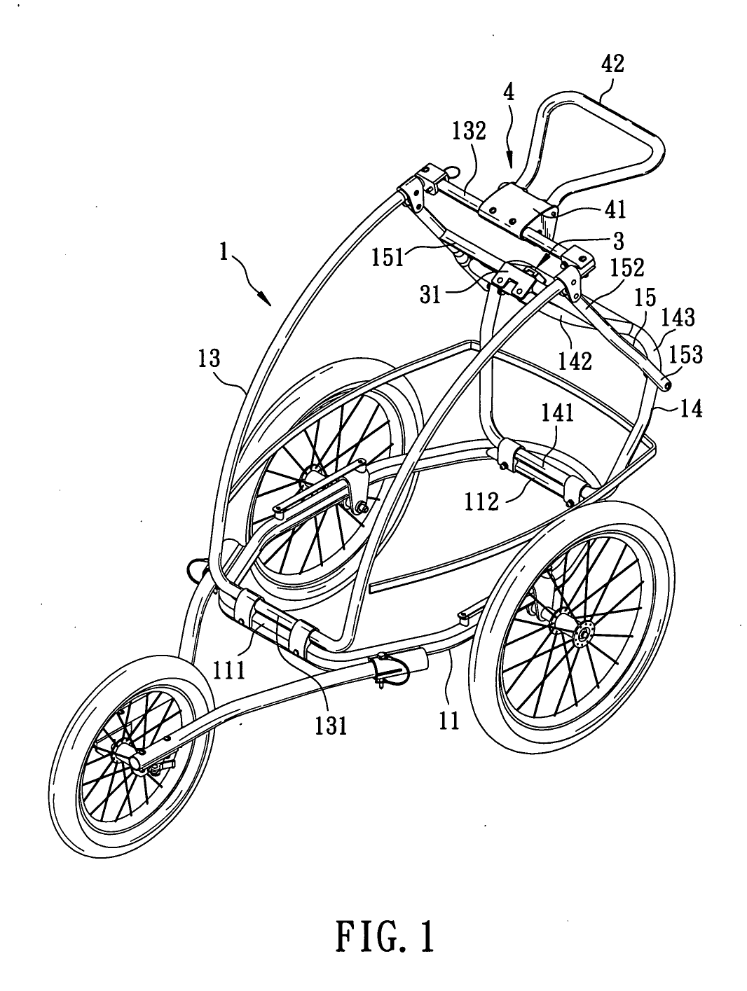

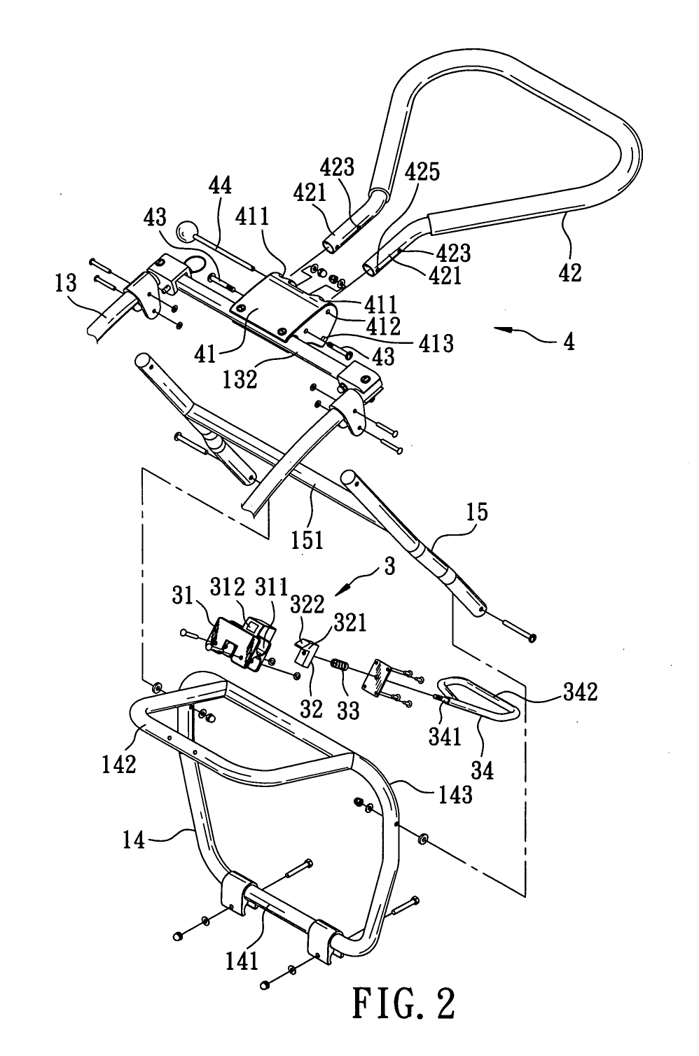

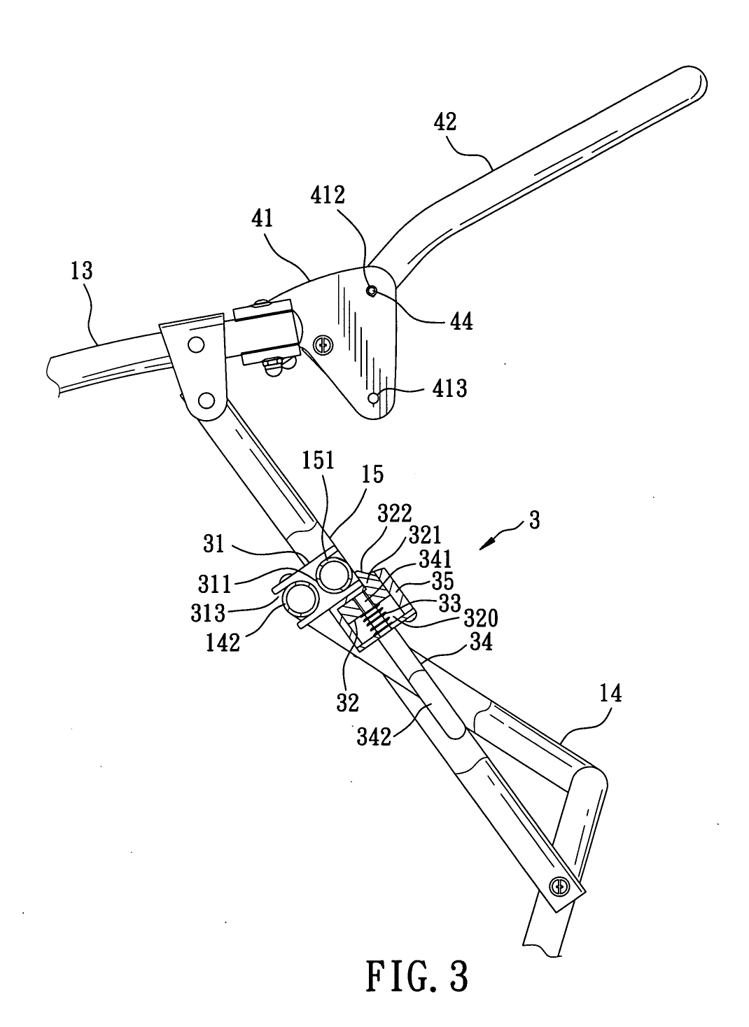

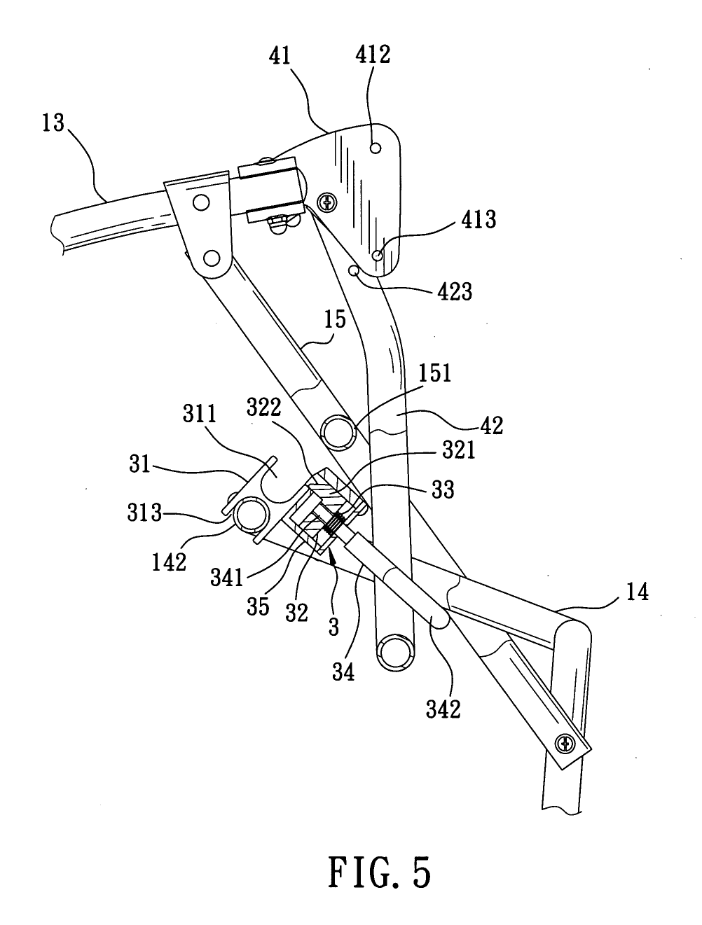

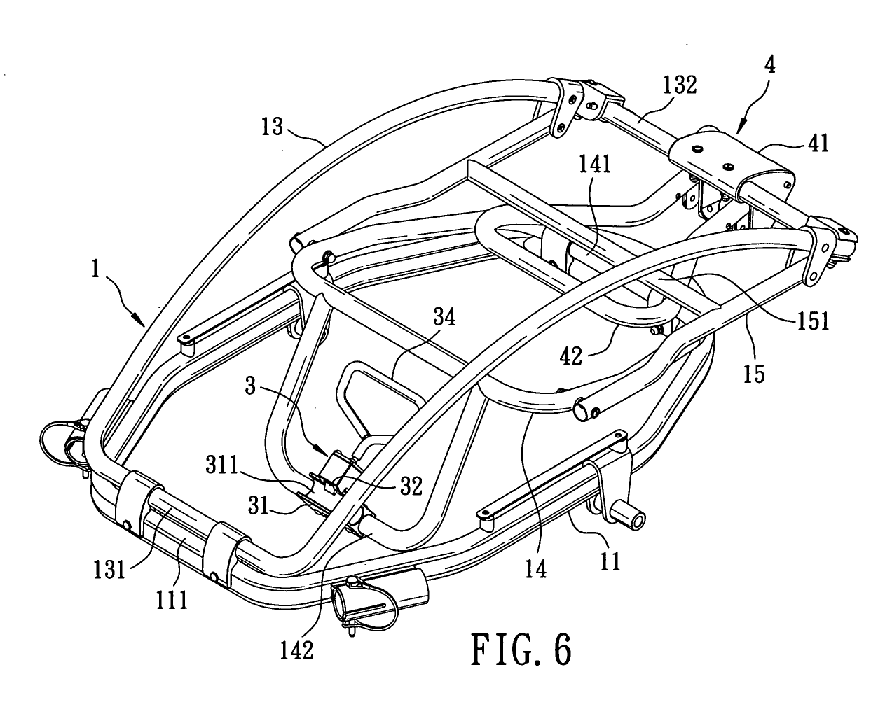

As shown in FIGS. 1 and 2, the preferred embodiment of a foldable vehicle according to the present invention is shown to include a skeleton 1, a coupling member 31, and a latch unit 3. The skeleton 1 is foldable between folded and extended positions (see FIGS. 6 and 1), and includes: a wheeled base frame 11 having front and rear frame parts 111, 112; a front supporting frame 13 having a lower frame part 131 pivoted to the front frame part 111 of the wheeled base frame 11 so as to be pivotable relative to the wheeled base frame 11 about a first axis, and an upper frame part 132 disposed opposite to the lower frame part 131; a rear supporting frame 14 having a lower frame part 141 pivoted to the rear frame part 112 of the wheeled base frame 11 so as to be pivotable relative to the wheeled base frame 11 about a second axis that is parallel to the first axis, and an upper frame part 143 disposed opposite to the lower frame part 141 of the rear supporting frame 14; a pivoting member 15 having a front part 152 pivoted to the upper frame part 132 of the front supporting frame 13 so as to be pivotable relative to the front supporting frame 13 about a third axis that is parallel to the first and second axes, a rear part 153 pivoted to the upper frame part 143 of the rear supporting frame 14 so as to be pivotable relative to the rear supporting frame 14 about a fourth axis that is parallel to the first, second and third axes, and a first crossbar 151 parallel to the first, second, third, and fourth axes; and a second crossbar 142 provided on one of the front and rear supporting frames 13, 14 (the second crossbar 142 is a part of the rear supporting frame 14 in this embodiment) and parallel to the first crossbar 151. The coupling member 31 is fixed on one of the first and second crossbars 151, 142 (the coupling member 31 is fixed to the second crossbar 142 in this embodiment), is coupled releasably to the other of the first and second crossbars 151, 142 (i.e., the first crossbar 151 in this embodiment) when the skeleton 1 is disposed at the extended position (see FIG. 3), and is uncoupled from the other of the first and second crossbars 151, 142 when the skeleton 1 is disposed at the folded position (see FIG. 5). The latch unit 3 is mounted on the coupling member 31 for preventing uncoupling between the coupling member 31 and the other of the first and second crossbars 151, 142.

In this embodiment, the coupling member 31 defines first and second recesses 311, 313 that open in opposite directions. The first and second crossbars 151, 142 extend respectively through the first and second recesses 311, 313 when the skeleton 1 is disposed at the extended position, as best shown in FIG. 3. The first crossbar 151 is disposed outwardly of the first recess 311 and the second crossbar 142 extends through the second recess 313 when the skeleton 1 is disposed at the folded position, as best shown in FIGS. 5 and 6.

The first and second recesses 311, 313 are aligned in a first direction. The latch unit 3 includes amounting seat 35 secured to the coupling member 31, and a spring-biased latch 32 that is mounted movably on the mounting seat 35, that has a tongue 321, and that is movable in a second direction transverse to the first direction between a locking position (see FIG. 3), in which at least a portion of the tongue 321 is aligned with the first crossbar 151 in the first direction when the skeleton 1 is disposed at the extended position, and an unlocking position (see FIG. 5), in which the tongue 321 is offset from the first crossbar 151 when the skeleton 1 is disposed at the extended position. The mounting seat 35 defines a latch-receiving space 320 for receiving the spring-biased latch 32 therein, and is formed with a hole 312 in spatial communication with the latch-receiving space 320. The tongue 321 of the spring-biased latch 32 extends outwardly of the latch-receiving space 320 through the hole 312 when the spring-biased latch 32 is disposed at the locking position, and is retracted into the latch-receiving space 320 when the spring-biased latch 32 is disposed at the unlocking position.

The latch unit 3 further includes a latch actuator 34 that has an actuator rod 341 extended into the latch-receiving space 320 to connect with the spring-biased latch 32, a latch handle 342 connected to the actuator rod 341 and disposed outwardly of the latch-receiving space 320, and an urging member 33 sleeved on the actuator rod 341 for urging the spring-biased latch 32 toward the coupling member 31. The tongue 321 is formed with an inclined guiding surface 322 such that during movement of the skeleton 1 from the folded position to the extended position, the first crossbar 151 pushes the tongue 321 against the urging action of the urging member 33 to retract into the spring-biased space 320 in the mounting seat 35 so as to be able to enter into the first recess 311 in the coupling member 31. The tongue 321 extends outwardly of the latch-receiving space 320 when the first crossbar 151 is received fully in the first recess 311 in the coupling member 31 so as to prevent undesired removal of the first crossbar 151 from the first recess 311 in the coupling member 31. To fold the skeleton 1, the latch handle 342 is pulled to withdraw the tongue 321 into the latch-receiving space 320, and the handle 42 is pressed subsequently and downwardly to cause pivoting movements of the front and rear supporting frames 13, 14 relative to the base frame 11.

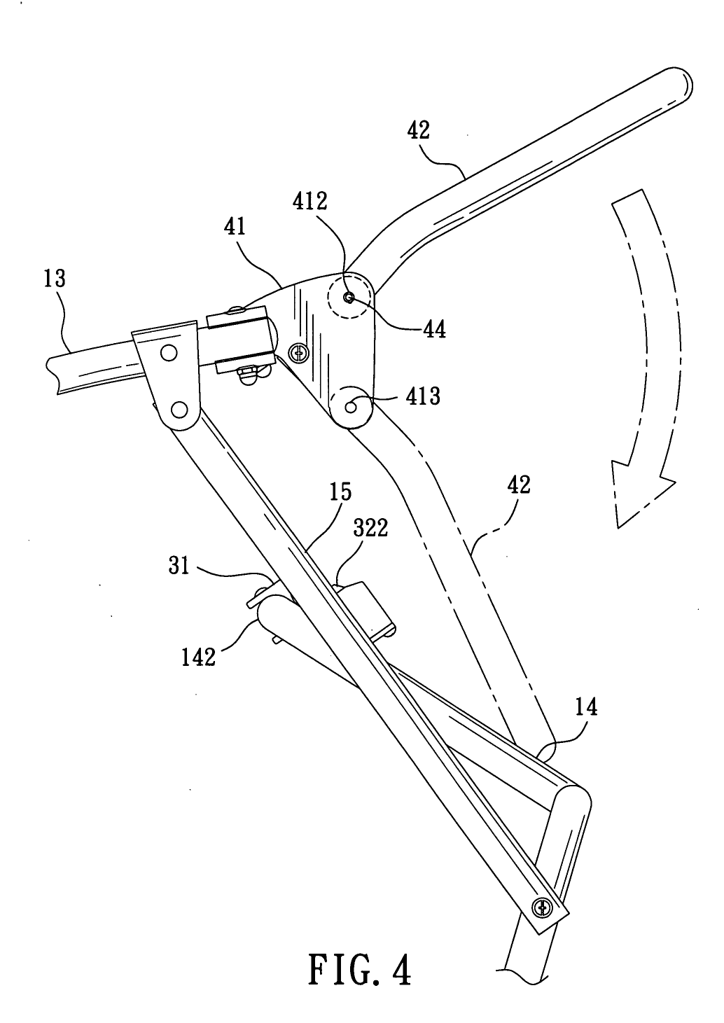

The foldable vehicle further includes a handle unit 4 that includes a handle seat 41, a handle 42, a pair of pivot pins 43, and a locking pin 44. The handle seat 41 has a bottom wall mounted on the upper frame part 132 of the front supporting frame 13, a rear wall formed with a pair of guiding grooves 411, and a pair of side walls formed with a pair of pivot holes for extension of the pivot pins 43 therethrough, a pair of first locking holes 412 and a pair of second locking holes 413. The handle 42 is generally U-shaped, and has two inserting ends 421 that extend respectively through the guiding grooves 411 in the rear wall of the handle seat 41, and that are formed with a pair of pivot holes 425 for extension of the pivot pins 43 therethrough, and a pair of locking holes 423. The handle 42 is pivotable relative to the front supporting frame 13 between first and second positions (see FIGS. 1 and 6). Referring to FIG. 4, the locking pin 44 is manually operable to be inserted through the first locking holes 412 in the side walls of the handle seat 41 and through the locking holes 423 in the inserting ends 421 of the handle 42 so as to retain the handle 42 at the first position, or to be inserted through the second locking holes 413 in the side walls of the handle seat 41 and through the locking holes 423 in the inserting ends 421 of the handle 42 so as to retain the handle 42 at the second position.

With the inclusion of the first and second crossbars 151, 142 and the coupling member 31 in the foldable vehicle of this invention, the aforesaid drawback associated with the prior art can be eliminated.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A foldable vehicle comprising:
a skeleton foldable between folded and extended positions and including
a wheeled base frame having front and rear frame parts,
a front supporting frame having a lower frame part pivoted to said front frame part of said wheeled base frame so as to be pivotable relative to said wheeled base frame about a first axis, and an upper frame part disposed opposite to said lower frame part,
a rear supporting frame having a lower frame part pivoted to said rear frame part of said wheeled base frame so as to be pivotable relative to said wheeled base frame about a second axis that is parallel to said first axis, and an upper frame part disposed opposite to said lower frame part of said rear supporting frame,
a pivoting member having a front part pivoted to said upper frame part of said front supporting frame so as to be pivotable relative to said front supporting frame about a third axis that is parallel to said first and second axes, a rear part pivoted to said upper frame part of said rear supporting frame so as to be pivotable relative to said rear supporting frame about a fourth axis that is parallel to said first, second and third axes, and a first crossbar parallel to said first, second, third, and fourth axes, and
a second crossbar provided on one of said front and rear supporting frames and parallel to said first crossbar;
a coupling member fixed to one of said first and second crossbars, coupled releasably to the other of said first and second crossbars when said skeleton is disposed at said extended position, and uncoupled from the other of said first and second crossbars when said skeleton is disposed at said folded position; and
a latch unit mounted on said coupling member for preventing uncoupling between said coupling member and the other of said first and second crossbars.

2. The foldable vehicle as claimed in claim 1, wherein said coupling member defines first and second recesses that open in opposite directions, said first and second crossbars extending respectively through said first and second recesses when said skeleton is disposed at said extended position, the other of said first and second crossbars being disposed outwardly of the respective one of said first and second recesses when said skeleton is disposed at said folded position.

3. The foldable vehicle as claimed in claim 2, wherein said first and second recesses are aligned in a first direction, said latch unit including a mounting seat secured to said coupling member and a spring-biased latch mounted movably on said mounting seat, said spring-biased latch having a tongue and being movable in a second direction transverse to said first direction between a locking position, in which at least a portion of said tongue is aligned with the other of said first and second crossbars in said first direction when said skeleton is disposed at said extended position, and an unlocking position, in which said tongue is offset from the other of said first and second crossbars when said skeleton is disposed at said extended position.

4. The foldable vehicle as claimed in claim 2, wherein said second crossbar is provided on said rear supporting frame, said coupling member being fixed to said second crossbar.
